(19) United States
(12) Patent Application Publication
(10) Pub. No.: US 2013/0145304 A1
(43) Pub. Date: Jun. 6, 2013

(54) CONFIRMING INPUT INTENT USING EYE TRACKING

(71) Applicants: Lisa Seacat DeLuca, San Francisco, CA (US); Brian D. Goodman, West Redding, CT (US); Soobaek Jang, Hamden, CT (US)

(72) Inventors: Lisa Seacat DeLuca, San Francisco, CA (US); Brian D. Goodman, West Redding, CT (US); Soobaek Jang, Hamden, CT (US)

(73) Assignee: INTERNATIONAL BUSINESS MACHINES CORPORATION, Armonk, NY (US)

(21) Appl. No.: 13/309,688

(22) Filed: Dec. 2, 2011

(51) Int. Cl. G06F 3/048

(52) U.S. Cl. 715/781

(57) ABSTRACT

A tool for detecting potential unintentional user input. Eye tracking technology is used to keep a record of where on a display a user is looking or if the user is even looking at the display. When input, such as a mouse selection or a tap on a touch screen, is received, the location of the selection is compared to a location of the user's gaze around when the selection was made. If the gaze location is outside of an acceptable range from the selection location, it is determined that the selection may have been in error and the selection is disregarded or a confirmation is requested of the user.

### FIELD OF THE INVENTION

The present invention relates generally to user interfaces and more particularly to detection of unintentional input into a user interface.

### BACKGROUND OF THE INVENTION

Devices capable of eye tracking can detect and measure eye movements, identifying a direction of a user's gaze or line of sight (typically on a screen). The acquired data can then be recorded for subsequent use, or, in some instances, directly exploited to provide commands to a computer in active interfaces. A basis for one implementation of eye-tracking technology involves light, typically infrared, reflected from the eye and sensed by a video camera or some other specially designed optical sensor. For example, infrared light generates corneal reflections whose locations may be connected to gaze direction. More specifically, a camera focuses on one or both eyes and records their movement as a viewer/user looks at some kind of stimulus. Most modern eye-trackers use contrast to locate the center of the pupil and use infrared and near-infrared non-collimated light to create a corneal reflection (CR). The vector between these two features can be used to compute gaze intersection with a surface after a simple calibration for an individual.

### SUMMARY

Aspects of an embodiment of the present invention disclose a method, computer system, and computer program product for detecting an unintentional user selection utilizing eye tracking. The method comprises a computer tracking eye movement of a user to determine a location on a display where the user's gaze intersects the display. The method further comprises the computer receiving a user selection via a user interface displaying on the display. The method further comprises the computer determining whether to perform subsequent instructions corresponding to the user selection based on whether the location on the display where the user's gaze intersects the display is within a defined region of the display corresponding to a location on the user interface where the user selection was received.

### BRIEF DESCRIPTION OF THE SEVERAL VIEWS OF THE DRAWINGS

FIG. 1 is a block diagram of a data processing system according to an embodiment of the present invention.

FIG. 2 is an exemplary graphical interface depicting an input error where a user of the data processing system of FIG. 1 selects an option on the interface while focusing the user's gaze elsewhere.

FIG. 3 is a flowchart of the steps of a selection verification program on the data processing system of FIG. 1 for detecting and warning of potential unintentional user selections, in accordance with an embodiment of the present invention.

FIG. 4 depicts a block diagram of internal and external components of the data processing system of FIG. 1.

### DETAILED DESCRIPTION

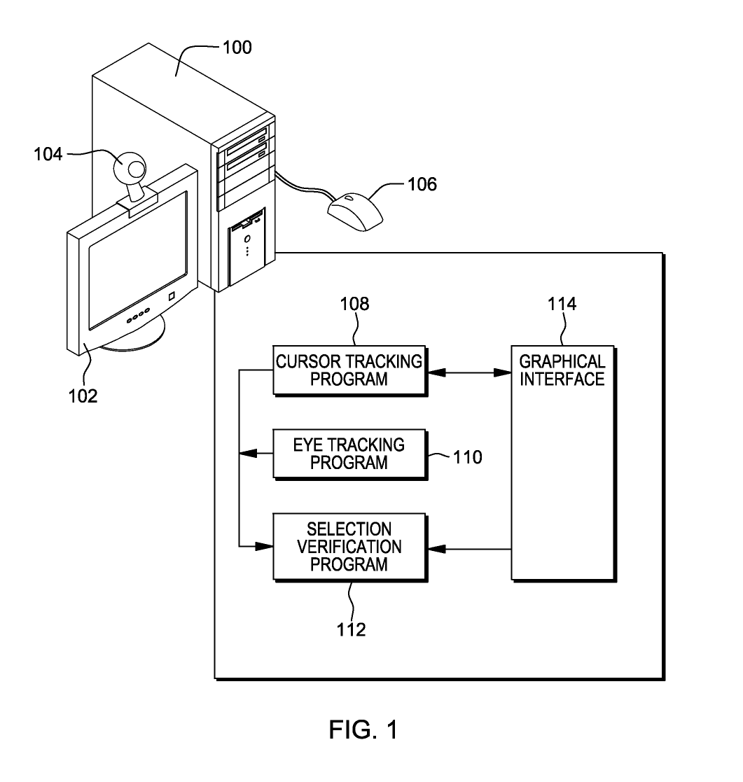

The present invention will now be described in detail with reference to the Figures. FIG. 1 illustrates a data processing system, generally designated 100, according to one embodiment of the present invention.

Data processing system 100 is connected to display 102 for displaying information to a user, camera 104 for tracking eye movements of the user, and mouse 106 for receiving selections from the user. Data processing system 100 may be a server computer, a client computer, a notebook, a laptop computer, a tablet computer, a handheld device or smart-phone, a thin client, or any other electronic device or computing system capable of receiving input from a user and executing computer program instructions. In another embodiment, data processing system 100 represents a computing system utilizing clustered computers and components to act as a single pool of seamless resources when accessed through a network. This is a common implementation for datacenters and for cloud computing applications.

Display 102 is depicted as a computer monitor. As an alternative to a connected external monitor, display 102 may be an incorporated display screen on data processing system 100. Such an implementation is used in tablet computers and smart phones. Similarly, camera 104 may be an integrated component of data processing system 100. Camera 104 is preferably an infrared camera or a camera with infrared capabilities. Mouse 106 controls the movement of a cursor (a movable indicator on a computer screen identifying the point that will be affected by input from a user) and receives selections or clicks from the user and transmits received selections to data processing system 100 to indicate a selection at the location of the cursor. Alternatively, a cursor may be moved by a track pad or track ball. In another alternate embodiment, data processing system 100 may be devoid of mouse 106 and user selections may be received via a touch screen. In an embodiment utilizing a touch screen, a cursor may also be moved via pressure on the touch screen. An alternate embodiment utilizing a touch screen may be devoid of a cursor altogether.

Data processing system 100 contains cursor tracking program 108 for tracking a location of the cursor relative to display 102. When a user wishes to make a selection, the user clicks a button on mouse 106 and data processing system 100 selects an object at the location of the cursor at the time of the click. In an embodiment utilizing a touch screen and devoid of a cursor, data processing system 100 is devoid of cursor tracking program 108 and any selections may be made at a location of display 102 receiving pressure (e.g., a tap with a finger).

Data processing system 100 also contains eye tracking program 110 for determining and tracking the location of a user's gaze on display 102. Eye tracking program 110 operates in conjunction with camera 104. Preferably, eye tracking program 110 maintains a record of a user's point of gaze at a given time for some range of time. For example, data processing system 100 may store a record of everywhere the user looked for the past ten seconds and the time the user looked there.

Selection verification program 112 operates on data processing system 100 and subsequent to a selection being made by a user, correlates the time of the selection with a location of the user's gaze at or near the time of the selection to determine if the selection was intended. Any action associated with a selection determined to be unintentional is prevented or requires additional verification to proceed.

Graphical interface 114 operates on data processing system 100 and works in conjunction with display 102 to visualize content, such as icons and a movable cursor, and allows a user to select a specific location. Graphical interface 114 may comprise one or more user interfaces such as an operating system interface and application interfaces. Graphical interface 114 may receive a selection, via mouse 106 or pressure on a touch screen, and report that selection to selection verification program 112.

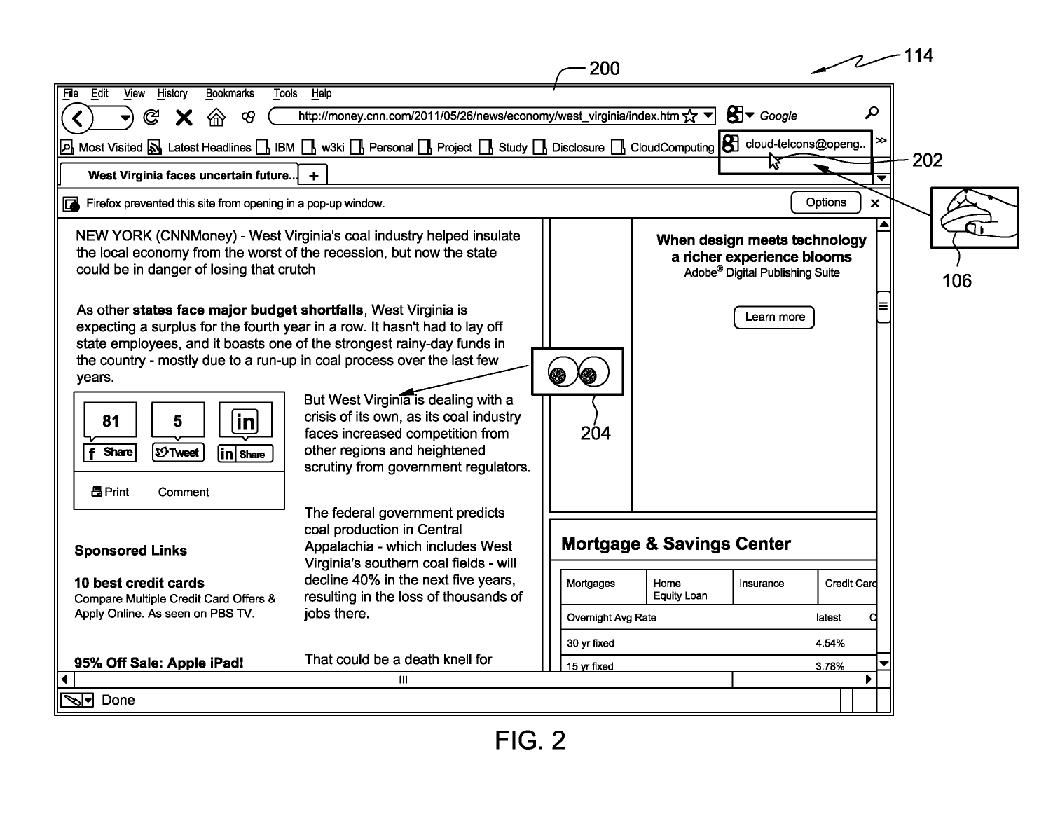

FIG. 2 depicts an exemplary embodiment of graphical interface 114. As shown, graphical interface 114 depicts user interface (UI) 200. UI 200 is a web-browser interface. Other UIs might include word processing interfaces, electronic mail interfaces, and other application interfaces allowing for a selection of an option by clicking a mouse or applying pressure at a specific location on a display of the interface.

Cursor 202 is positioned over a link that may be selected by the user. In this instance, mouse 106 controls cursor 202. Concurrently with cursor 202 being located on the link, a gaze 204 of the user is on text within UI 200. A click at mouse 106 indicates a selection of the link where cursor 202 is located in UI 200. However, as the user is currently reading, data processing system 100 determining the location of the user's gaze 204 would in this instance indicate that the selection was unintentional. While the damage in a browser would be nominal as the user could subsequently select a “back” button, closing a document unintentionally or submitting an incomplete document or electronic mail message could have farther reaching consequences. In an embodiment where data processing system 100 is a smart phone, unintentional selections may occur at an accidental brush of the hand or even while the phone is in a user's pocket.

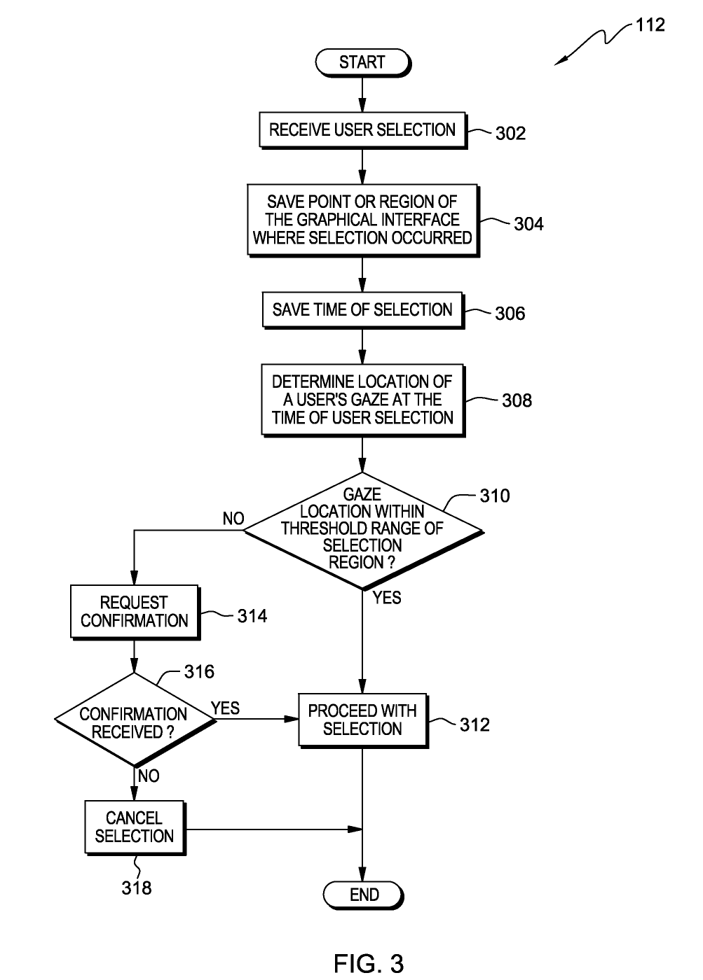

FIG. 3 is a flowchart of the steps of selection verification program 112 for detecting and warning of potential unintentional user selections, in accordance with an embodiment of the present invention.

Selection verification program 112 receives a user selection (step 302) typically through a user interface such as graphical interface 114. The selection may have been made via a mouse click in conjunction with cursor tracking program 108 or via pressure on a touch screen display.

Selection verification program 112 subsequently saves the location of the interface where the selection took place (step 304). In the preferred embodiment, the location of the selection is a region of coordinates representative of a link or button or option displayed on the interface that was selected by the user. In another embodiment, the location of the selection is the point or coordinate set representative of the exact spot selected by the user. In addition to saving the location, in one embodiment, a time when the selection was made is also saved (step 306). The time may be saved as an internal clock count of data processing system 100 and is preferably saved down to the millisecond.

Selection verification program 112 determines a location of the user's gaze at or near the time of the user selection (step 308). In the preferred embodiment, data processing system 100 keeps a running record of the location of the user's gaze. The time of the user selection can then be compared to the running record to determine the location of the user's gaze when the selection was made. A person of skill in the art will recognize that, in one embodiment, the data processing system 100 may determine the location of a user's gaze as soon as a user selection is received and compare the determined location to the selection without keeping track of times. However, the time keeping method is preferred as different systems have different processing speeds and using time stamps will allow selection verification program 112 to use times exactly matching the time of the selection as well as the location of the user's gaze at times prior to the selection. For example, selection verification program 112 might also compare the location of the user's gaze one second prior (or multiple seconds, milliseconds, etc.) to the selection as the user might look at where he wants the cursor to go and look away prior to actually selecting it. As such, the determined location of the user's gaze might comprise any location leading up to and concurrent with the user selection.

Selection verification program 112 subsequently determines whether the location of the user's gaze (or one of a series of locations at or near the time of the user selection) is within a threshold range of the selection (decision block 310). In one embodiment, the threshold range is any location within the saved region (of step 304) of the user selection. In another embodiment, the threshold range is a location within a number of pixels (e.g., 50, etc.) in any direction from the saved region or point of the user selection.

If the location of the user's gaze is within the threshold region (yes branch of decision 310), selection verification program 112 proceeds with instructions corresponding to the selection (step 312). If the location of the user's gaze is not within the threshold region (no branch of decision 310), selection verification program 112 requests confirmation of the selection (step 314).

In one embodiment, the confirmation request is as simple as a radio button (option button) allowing the user to select an option confirming the original user selection. In an alternate embodiment, selection verification program 112 might, concurrent with the radio button, highlight the selection region to notify the user of where the original selection took place. In another embodiment still, the confirmation request might suggest other potential intended links/selections based on the actual location of the user's gaze.

Subsequent to the confirmation request, selection verification program 112 determines whether a confirmation was received (decision block 316). If there is a user confirmation, selection verification program 112 proceeds with instructions corresponding to the selection (step 312). If there is not a confirmation, selection verification program 112 cancels the selection (step 318).

In one embodiment, selection verification program 112 determines, based on a history of confirmation responses, a time range prior to the user selection from which to compare the location of the user's gaze with the location of the user selection. In one implementation, selection verification program 112 keeps a history of confirmations from the user that a user selection was intended, and, the corresponding, most recent time the user's gaze intersected the location of the confirmed user selection. After a history of confirmations has been stored, selection verification program 112 determines a range of time from which program 112 can assume that if the location of the user's gaze intersects the location of the user selection within the determined range of time, then the user selection was intended.

In another embodiment, selection verification program 112 may be devoid of step 314 and decision block 316, and upon determining that the location of the user's gaze is not within a threshold range of the selection (no branch of decision 310), simply cancels the selection (step 318). In such an embodiment, if the user had in fact intended the selection, the user would have to re-select and would likely now look at the location of the selection to ensure that he or she is clicking in the correct place. In this embodiment, data processing system 100 may be considered “locked” or unable to operate without the user looking at the correct location. Hence, if the user is not looking at display 102 at all, no user input may be selected via the user interface. This would prevent such mistakes as “pocket dialing” where data processing system 100 is a smart phone.

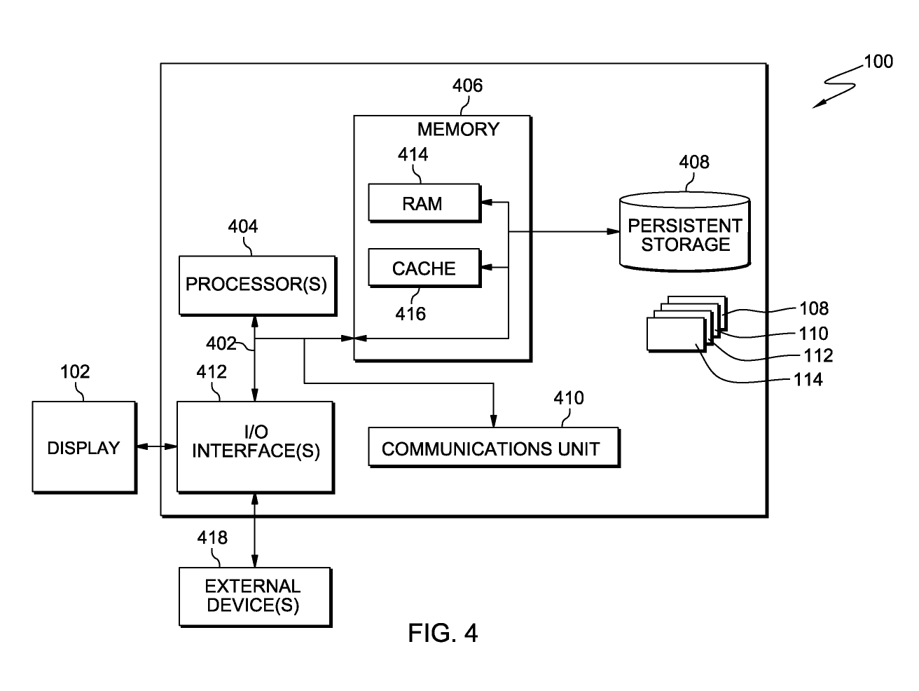

FIG. 4 depicts a block diagram of components of data processing system 100 in accordance with an illustrative embodiment. It should be appreciated that FIG. 4 provides only an illustration of one implementation and does not imply any limitations with regard to the environment in which different embodiments may be implemented. Many modifications to the depicted environment may be made.

Data processing system 100 includes communications fabric 402, which provides communications between processor(s) 404, memory 406, persistent storage 408, communications unit 410, and input/output (I/O) interface(s) 412.

Memory 406 and persistent storage 408 are examples of computer-readable tangible storage devices. A storage device is any piece of hardware that is capable of storing information, such as, data, program code in functional form, and/or other suitable information on a temporary basis and/or permanent basis. Memory 406 may be, for example, one or more random access memories (RAM) 414, cache memory 416, or any other suitable volatile or non-volatile storage device.

Cursor tracking program 108, Eye tracking program 110, and selection verification program 112 are stored in persistent storage 408 for execution by one or more of the respective processors 404 via one or more memories of memory 406. In the embodiment illustrated in FIG. 4, persistent storage 408 includes flash memory. Alternatively, or in addition to, persistent storage 408 may include a magnetic disk storage device of an internal hard drive, a solid state drive, a semiconductor storage device, read-only memory (ROM), EPROM, or any other computer-readable tangible storage device that is capable of storing program instructions or digital information.

The media used by persistent storage 408 may also be removable. For example, a removable hard drive may be used for persistent storage 408. Other examples include an optical or magnetic disk that is inserted into a drive for transfer onto another storage device that is also a part of persistent storage 408, or other removable storage devices such as a thumb drive or smart card.

Communications unit 410, in these examples, provides for communications with other data processing systems or devices. In these examples, communications unit 410 includes one or more network interface cards. Communications unit 410 may provide communications through the use of either or both physical and wireless communications links. In another embodiment still, data processing system 100 may be devoid of communications unit 410. Cursor tracking program 108, Eye tracking program 110, and selection verification program 112 may be downloaded to persistent storage 408 through communications unit 410.

I/O interface(s) 412 allows for input and output of data with other devices that may be connected to data processing system 100. For example, I/O interface 412 may provide a connection to external devices 418 such as camera 104, mouse 106, a keyboard, keypad, a touch screen, and/or some other suitable input device. I/O interface(s) 412 also connects to display 102.

Display 102 provides a mechanism to display data to a user and may be, for example, a computer monitor. Alternatively, display 102 may be an incorporated display and may also function as a touch screen.

The aforementioned programs can be written in various programming languages (such as Java or C++) including low-level, high-level, object-oriented or non object-oriented languages. Alternatively, the functions of the aforementioned programs can be implemented in whole or in part by computer circuits and other hardware (not shown).

Based on the foregoing, a method, computer system, and computer program product have been disclosed for detecting potential unintentional user selections. However, numerous modifications and substitutions can be made without deviating from the scope of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the blocks may occur out of the order noted in the figures. Therefore, the present invention has been disclosed by way of example and not limitation.

What is claimed is:

1. A method for verifying a user selection, the method comprising the steps of:
a computer system tracking eye movement of a user to determine a location of the user's gaze on a display;
the computer system receiving a user selection at a location on the display; and
the computer system verifying the user selection based on the location of the user's gaze and the location of the user selection.

2. The method of claim 1, wherein the step of the computer system verifying the user selection comprises the steps of:
the computer system determining that the location of the user's gaze is within a defined region of the display corresponding to the location of the user selection, and in response, the computer system performing one or more instructions corresponding to the user selection.

3. The method of claim 1, wherein the step of the computer system verifying the user selection comprises the steps of:
the computer system determining that the location of the user's gaze is not within a defined region of the display corresponding to the location of the user selection;
the computer system subsequently requesting confirmation from the user that the user selection was intended; and
in response to receiving confirmation from the user that the user selection was intended, the computer system performing one or more instructions corresponding to the user selection.

4. The method of claim 1, wherein the step of the computer system verifying the user selection comprises the steps of:
the computer system determining that the location of the user's gaze is not within a defined region of the display corresponding to the location of the user selection;
the computer system subsequently displaying one or more alternative user selections based on the location of the user's gaze; and
in response to receiving a selection of one of the one or more alternative user selections, the computer system performing one or more instructions corresponding to the one of the one or more alternative user selections.

5. The method of claim 1,
wherein the step of the computer system tracking eye movement of the user to determine the location of the user's gaze on the display, further comprises the computer system storing a record of locations and corresponding times of the user's gaze on the display; and
wherein the step of the computer system receiving the user selection at a location on the display, further comprises the computer system storing a relative time of the user selection; and
wherein the step of the computer system verifying the user selection comprises the computer system determining whether to perform one or more instructions corresponding to the user selection based on whether a location of the user's gaze, at or near the relative time of the user selection, is within a defined region of the display corresponding to the location of the user selection.

6. The method of claim 5, wherein the location of the user's gaze, at or near the relative time of the user selection, is any location from the record of locations where the respective corresponding time is less than one second prior to the relative time of the user selection and is not after the relative time of the user selection.

7. The method of claim 5, wherein the location of the user's gaze, at or near the relative time of the user selection, is any location from the record of locations where the respective corresponding time is within a range of times, wherein the range of times is determined based on a history of one or more user selections confirmed by the user and, for each respective confirmed user selection from the one or more confirmed user selections, a location of the user's gaze within a defined region of the display corresponding to a location of the respective confirmed user selection, nearest in time to the respective confirmed user selection, and the corresponding time of the location.

8. The method of claim 5, wherein the defined region of the display corresponding to the location of the user selection comprises a region of coordinates on the display including at least the location of the user selection.

9. The method of claim 1, wherein the step of the computer system verifying the user selection comprises the steps of:
the computer system determining that the location of the user's gaze is not within a defined region of the display corresponding to the location of the user selection, and in response, the computer system determining not to perform instructions corresponding to the user selection.

10. A computer program product for verifying a user selection, the computer program product comprising:
one or more computer-readable tangible storage devices and program instructions stored on at least one of the one or more storage devices, the program instructions comprising:
program instructions to track eye movement of a user to determine a location of the user's gaze on a display;
program instructions to receive a user selection at a location on the display; and
program instructions to verify the user selection based on the location of the user's gaze and the location of the user selection.

11. The computer program product of claim 10, wherein the program instructions to verify the user selection comprise program instructions to:
determine that the location of the user's gaze is within a defined region of the display corresponding to the location of the user selection, and in response, perform one or more instructions corresponding to the user selection.

12. The computer program product of claim 10, wherein the program instructions to verify the user selection comprise program instructions to:
determine that the location of the user's gaze is not within a defined region of the display corresponding to the location of the user selection;
request confirmation from the user that the user selection was intended; and
in response to receiving confirmation from the user that the user selection was intended, perform one or more instructions corresponding to the user selection.

13. The computer program product of claim 10, wherein the program instructions to verify the user selection comprise program instructions to:
determine that the location of the user's gaze is not within a defined region of the display corresponding to the location of the user selection;
display one or more alternative user selections based on the location of the user's gaze; and
in response to receiving a selection of one of the one or more alternative user selections, perform one or more instructions corresponding to the one of the one or more alternative user selections.

14. The computer program product of claim 10,
wherein the program instructions to track eye movement of the user to determine the location of the user's gaze on the display, further comprise program instructions to store a record of locations and corresponding times of the user's gaze on the display; and
wherein the program instructions to receive the user selection at a location on the display, further comprise program instructions to store a relative time of the user selection; and
wherein the program instructions to verify the user selection comprise program instructions to determine whether to perform one or more instructions corresponding to the user selection based on whether a location of the user's gaze, at or near the relative time of the user selection, is within a defined region of the display corresponding to the location of the user selection.

15. The computer program product of claim 14, wherein the location of the user's gaze, at or near the relative time of the user selection, is any location from the record of locations where the respective corresponding time is less than one second prior to the relative time of the user selection and is not after the relative time of the user selection.

16. The computer program product of claim 14, wherein the location of the user's gaze, at or near the relative time of the user selection, is any location from the record of locations where the respective corresponding time is within a range of times, wherein the range of times is determined based on a history of one or more user selections confirmed by the user and, for each respective confirmed user selection from the one or more confirmed user selections, a location of the user's gaze within a defined region of the display corresponding to a location of the respective confirmed user selection, nearest in time to the respective confirmed user selection, and the corresponding time of the location.

17. The computer program product of claim 14, wherein the defined region of the display corresponding to the location of the user selection comprises a region of coordinates on the display including at least the location of the user selection.

18. A computer system for verifying a user selection, the computer system comprising:
one or more processors, one or more computer-readable memories, one or more computer-readable tangible storage devices and program instructions which are stored on the one or more storage devices for execution by the one or more processors via the one or more memories, the program instructions comprising:
program instructions to track eye movement of a user to determine a location of the user's gaze on a display;
program instructions to receive a user selection at a location on the display; and
program instructions to verify the user selection based on the location of the user's gaze and the location of the user selection.

19. The computer system of claim 18, wherein the program instructions to verify the user selection comprise program instructions to:
determine that the location of the user's gaze is within a defined region of the display corresponding to the location of the user selection, and in response, perform one or more instructions corresponding to the user selection.

20. The computer system of claim 18, wherein the program instructions to verify the user selection comprise program instructions to:
determine that the location of the user's gaze is not within a defined region of the display corresponding to the location of the user selection;
request confirmation from the user that the user selection was intended; and
in response to receiving confirmation from the user that the user selection was intended, perform one or more instructions corresponding to the user selection.

21. The computer system of claim 18, wherein the program instructions to verify the user selection comprise program instructions to:
determine that the location of the user's gaze is not within a defined region of the display corresponding to the location of the user selection;
display one or more alternative user selections based on the location of the user's gaze; and
in response to receiving a selection of one of the one or more alternative user selections, perform one or more instructions corresponding to the one of the one or more alternative user selections.

22. The computer system of claim 18,
wherein the program instructions to track eye movement of the user to determine the location of the user's gaze on the display, further comprise program instructions to store a record of locations and corresponding times of the user's gaze on the display; and
wherein the program instructions to receive the user selection at a location on the display, further comprise program instructions to store a relative time of the user selection; and
wherein the program instructions to verify the user selection comprise program instructions to determine whether to perform one or more instructions corresponding to the user selection based on whether a location of the user's gaze, at or near the relative time of the user selection, is within a defined region of the display corresponding to the location of the user selection.

23. The computer system of claim 22, wherein the location of the user's gaze, at or near the relative time of the user selection, is any location from the record of locations where the respective corresponding time is less than one second prior to the relative time of the user selection and is not after the relative time of the user selection.

24. The computer system of claim 22, wherein the location of the user's gaze, at or near the relative time of the user selection, is any location from the record of locations where the respective corresponding time is within a range of times, wherein the range of times is determined based on a history of one or more user selections confirmed by the user and, for each respective confirmed user selection from the one or more confirmed user selections, a location of the user's gaze within a defined region of the display corresponding to a location of the respective confirmed user selection, nearest in time to the respective confirmed user selection, and the corresponding time of the location.

25. The computer system of claim 22, wherein the defined region of the display corresponding to the location of the user selection comprises a region of coordinates on the display including at least the location of the user selection.
